(19) United States
(12) Patent Application Publication
(10) Pub. No.: US 2012/0096554 A1
(43) Pub. Date: Apr. 19, 2012

(54) Malware identification

(75) Inventor: Odd Wandenor Stranne, Odsmal (SE)

(73) Assignee: Lavasoft AB

(21) Appl. No.: 12/923,987

(22) Filed: Oct. 19, 2010

(51) Int. Cl. G06F 11/00

(52) U.S. Cl. 726/24

(57) ABSTRACT

A method for identifying a data collection as malware, comprising the steps of parsing the data collection to generate program code and to verify conformance to a language syntax, emulating the interaction between the program code and a processor, detecting presence of a portion of the program code that is likely to have been added to the program code for the purpose of avoiding detection by malware detection programs, and, in the presence of such code, identifying the data collection as malware.

According to the present invention, the emulation of the processor is focused on identifying code that has been added to a data collection to avoid detection by existing malware detection programs.

An advantage with basing a malware assessment on the presence of such “suspicious” code, is that the emulation required to identify suspicious code typically is much less complicated than emulation required to identify malicious behavior in the actual malware code.

### FIELD OF THE INVENTION

The present invention relates to computer systems and the process of identifying malware and/or viruses on such systems.

### TECHNICAL BACKGROUND OF THE INVENTION

For as long as data has been shared between computers, computer viruses have existed. When a virus infected program file is executed, the virus is activated and may cause unwanted effects, sometimes harmful to the computer system. Computer viruses are typically short sections of low level program code incorporated in an otherwise legitimate program file.

With the rapid growth of Internet, accessible bandwidth, and the associated sharing of enormous amounts of data between computers, it has become increasingly more difficult to control which files enter a system. At the same time as legitimate files are downloaded, also other, malicious software files may be downloaded unless the user is extremely cautious.

Such malicious software, or malware, has become increasingly common, and includes, for example spyware, trojans, and worms. Once activated, malware may write to system registry files (e.g. Windows Registry), influence on-going program processes, and disturb the performance of the system. As a few examples, a spyware may collect and communicate information about the system and its user to an outside party; a trojan may deactivate protective software to allow additional, even more malicious software to enter the system.

With the massive surge in unique malware samples that has been witnessed during the past few years, which is threatening the Internet community as a whole, there is an increasing need for proactive and generic detection of malware files.

Typically, a malicious file or set of related files cannot be detected by security software until they have been analyzed by the makers of said software and appropriate signatures for identification have been created and distributed.

There are several problems with this approach. First, the time it takes between a malware file surfacing and until it is being positively identified as malware. The delay between these events create a window where customer machines and networks are left unprotected, at the mercy of the particular malware file or strain. The second problem relates to the number of unique samples in distribution. It becomes difficult to manage and process such volumes and even just the set of file signatures is requiring extensive space in storage and in transmission.

Under these circumstances, there is a need for methods which are able to recognize a malware based on properties of its behavior. To this end, the suspected file can be run on an emulated environment, and the execution of the file can be monitored, in order to determine if a sequence or set of classified prohibited functions are referenced. In order to maximize the number of files that can be successfully analyzed in this manner, the emulated environment is created to be as complete as possible. As a consequence, this leads to an overly complex process, where the time required to build and maintain the emulated environments is comparable to that required to develop the systems themselves.

Conventional emulation methods can be highly effective but also commonly fail to correctly determine that a file is malware. One of the reasons for failure is that conventional methods have a disposition towards allowing invalid operations. By allowing invalid operations, the execution is not aborted, and a larger execution history can be captured.

### GENERAL DISCLOSURE OF THE INVENTION

It is an object of the present invention to provide an alternative way to identify malware and/or viruses.

This and other objects are achieved by a method for identifying a data collection as malware or virus, comprising the steps of parsing said data collection to generate program code and to verify conformance to a language syntax, emulating the interaction between said program code and a processor, detecting presence of a portion of the program code that is likely to have been added to the program code for the purpose of avoiding detection by malware detection programs, and in the presence of such code, identifying said data collection as virus or malware.

According to the present invention, the emulation of the processor is focused on identifying code that has been added to a data collection to avoid detection by existing malware detection programs.

The invention is based on the realization that code added by a post programming process, typically used to disguise malware or viruses, is normally possible to recognize as different from “normal” code generated by a compiler. Therefore, the method according to the present invention emulates code in order to detect operations that are not defined or expected in the current execution context. Such unexpected or undefined operations are treated as “suspicious”, indicating that this code has not been generated by a compiler but rather been added during a post programming activity. For example, the added program code may have been added to the program code during an expansion phase of a polymorphic malware, a polymorphic virus or decryption layer.

An advantage with basing a malware assessment on the presence of such “suspicious” code, is that the emulation required to identify suspicious code typically is much less complicated than emulation required to identify malicious behavior in the actual malware code.

The emulating step may include emulation of at least one of a processor stack, processor registers, and processor instructions. According to some embodiment of the present invention, a limited emulation, including e.g. only registers and stack, is necessary to identify suspicious code. According to other embodiments, a more complete emulation may be advantageous.

The emulation may further be restricted to keeping track of register status, i.e. without keeping track of actual values. Such a restriction makes the emulation very easy to implement, and much less complex than conventional emulation software. As mentioned above, in some embodiments of the invention a more complete emulation may be advantageous

### BRIEF DESCRIPTION OF THE DRAWINGS

FIG. 1 illustrates an anti-malware engine in relation to a collection of data that is to be analyzed.

FIG. 2 illustrates a possible implementation of an anti-malware engine and some of the processes that may occur inside it, incorporating subject matter described herein.

FIG. 3 illustrates a procedure according to an embodiment of the present invention as it may appear inside a code emulator module.

### DETAILED DESCRIPTION OF PREFERRED EMBODIMENTS

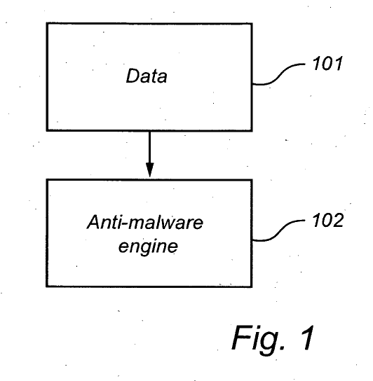

FIG. 1 shows a malware detection system 102 running on a suitable computer system under a conventional operating system. A data collection 101, “data”, is entered into the computer system via a suitable input interface. The data 101 may represent a computer file intended to be scanned for detection of any malware present in the file. The data may be requested by the malware detection system 102, and supplied by other components or by the operating system, or it may be passed to the malware detection system 102 by some other entity in an explicit request to analyze the data for malware traces.

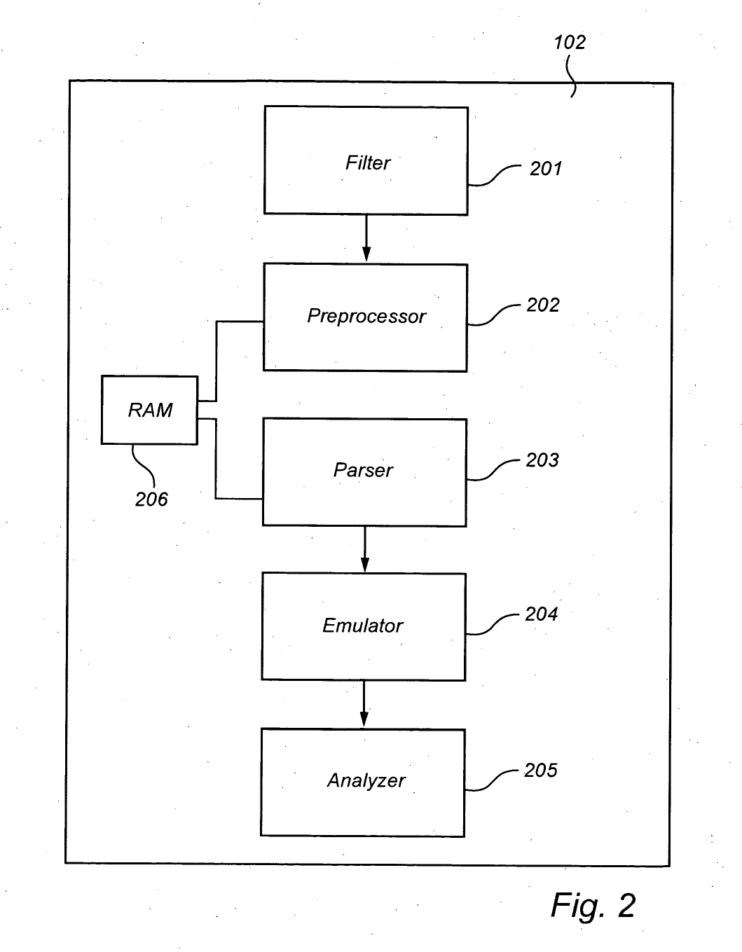

FIG. 2 shows some of the processes that may occur inside the malware detection system 102.

A filter process 201 looks at the incoming data collection 101 to determine if it is of a supported format, and if the system should proceed with the analysis. If proceeding, the data is passed to a preprocessor 202 that prepares the data for analysis. The preprocessor is arranged to receive the data and generate “prepared data” that is more easily digested by the following modules. In one possible embodiment of the invention, the preprocessor may for example remove layers of compression or encoding from the data, thereby generating the prepared data.

The prepared data is stored in a memory 206, and processed, one operation at a time, in a parser 203, a code emulation module 204, and an analyzer module 205. These modules will perform a method according to an embodiment of the present invention to determine if the data collection 101 should be identified as malware.

More specifically, the code emulation module 204 and analyzer 205 are adapted to emulate and analyze individual operations that have been parsed by the parser 203, to identify suspicious portions of code. By “suspicious” code is intended code that does not seem to have been generated by a conventional compiler, and therefore implies post-programming activity such as a packer, a protector, or a polymorphic virus/malware. The detection of such suspicious code can thus be taken as an indicator that this code has been included as part of a disguise operation, such as that performed by a polymorphic virus/malware.

The processes described above may be implemented in software and/or hardware. In case of software implementation, the software may be stored in the memory 206 and executed by a processor (not shown).

In the following, various situations will be described that may be used as indications of suspicious program code. The situations are most relevant and effective when applied on function entries, such as the application code entry point. Examples that follow are taken from actual malware samples as well as legitimate applications and the Microsoft Windows operating system (Intel x86).

### Uninitialized Source Operands

A first situation is when contents of an uninitiated variable or register is used by the code as a source operand. In normal programming such use is not meaningful, as the content is not known to the program. At the code entry point, the CPU registers and stack contents are undefined. The values of registers etcetera may be known for some specific version of the operating system but it is improper to depend on such undefined values, and use them as operands in following instructions. An example of assembly code where this situation is at hand is given below.

Win32.Trojan.Pincav

| | |
|---|---|
| 01 push | ecx |
| 02 mov | [esp],dx |
| 03 mov | d,[esp],0F6E5ECBF |
| 04 pushad | |
| 05 mov | d,[esp][01C],0382918CC |
| 06 push | ebx |
| 07 lea | esp,[esp][020] |

The first instruction places the (undefined) value of the ecx register on the top of the stack. This is done to preserve a register value and is not in itself an indicator of suspicious code, even though ecx is not defined. The second instruction also operates on the stack, but in a more explicit way. It partially overwrites the previously saved ecx register by copying the value of the dx register on top of it. It is a definitive error to copy from the uninitialized dx register and this indicates suspicious code.

Win32.Trojan.Scar

| | |
|---|---|
| 01 push | ebp |
| 02 mov | ebp,esp |
| 03 sub | esp,00C |
| 04 sub | ecx,edx |
| 05 lea | ecx,[eax][edx] |
| 06 push | 0 |
| 07 call | GetModuleHandleA |

In the first two instructions 01, 02, the ebp register is preserved before it receives the current stack pointer. The ebp register is the so-called base pointer for the function stack frame. In instruction 03, space is made on the stack for storing function local variables. The first few instructions are standard procedure and included in most function prologues. In instruction 04, on the other hand, we see a request to subtract the edx register from the ecx register. This is essentially a request to subtract an undefined value from another undefined value, and is clearly an operation indicating suspicious code.

Win32.Trojan.Scar, other sample

| | |
|---|---|
| 01 mov | edi,edi |
| 02 push | ebp |
| 03 mov | ebp,esp |
| 04 sub | esp,03C |
| 05 push | edi |
| 06 push | esi |
| 07 add | ebx,edi |
| 08 call | GetProcessHeap |

This example appears to be suspicious already at the first instruction. It copies from the undefined register edi which would normally be an error. In this case however, the copy destination is also edi, and considering that the mov instruction does not update CPU flags, the instruction effectively becomes a no-op. In fact, this instruction-operand combination is quite common and used in operating system code to ensure an instruction sequence that can easily be patched, should the need arise.

Had we detected and triggered on this operation it would have resulted in a number of false positives. This really shows the subtle complexities and the platform knowledge required for successfully implementing the invention in some given environment.

Instructions 02-04 are known from the previous example. So are instructions 05,06 that preserve register values on the stack. What makes the code suspicious is instruction 07 that adds two undefined values.

### Reference to Negative Stack

Another manifestation of suspicious behavior is when an operand refers to a negative stack location. Operating on data in negative stack may lead to unpredictable results, so normally this does not occur in compiler generated code. The use of a negative stack is much more likely in generated garbage code. It is more likely to be used with the source operand, but a dereference on the source operand is not necessary. For example, the following example can be considered:

| | |
|---|---|
| 01 lea | reg32, [esp−x] |

This represents loading the address of a negative stack location. Being garbage code the register will probably be overwritten soon but this behavior alone may in some cases be enough to determine that the code is suspicious.

### Invalid Operation Sequences

A variation of invalid source operands relates to invalid sequences of operations, i.e. operations that logically belong together and where the final operation is to dismiss, or overwrite, the result of previous steps. Such sequences will typically not be seen in compiler generated code, and are thus considered to be suspicious. For this type of analysis, it may be useful to consider function borders or basic blocks as the scope for analysis. Basic blocks are known to be code blocks with the properties of exactly one entry and one exit.

Here's one of the more simple examples that can be used to illustrate the idea:

01 mov eax, ecx
02 mov eax, 7

At instruction 01 the value of the ecx register is copied into the eax register. This would typically indicate that a computation is about to take place, or that the eax register is being used as temporary storage. In either case we can expect that the value in eax will be used in subsequent steps. At instruction 02 eax has a new value assigned to it, before the result of the previous “computation” is used or stored. This clearly makes instruction 01 superfluous. Another example that adds a few more elements:

01 mov eax, ecx
02 mov edx, ecx
03 not eax
04 inc eax
05 mov eax, ecx

Instruction 01 is known from the previous example. Instruction 02 is interlaced with the operations on eax but has nothing to do with them. This is perfectly normal. Instruction 03 applies the Not operation on the value in eax. Instruction 04 increments the value in eax. The problem with this code is at instruction 05 because the outcome is constant. And, as explained in the previous example, the result of the computations is destroyed before it can be used.

Note, however, that there may be more things to consider. Step 05 is clearly the trigger, but it's not a definitive trigger until another subsequent instruction has updated the CPU flags. The sequence that is being analyzed is not only represented by the eax register, but also by the flags affected by both the Not instruction and the Inc instruction. So if at imaginary instruction 06, a flag such as the Zero flag is read, then the whole sequence is validated and there is nothing to trigger on.

### Disguised Unconditional Branch

One type of invalid operation sequences deal with disguised unconditional execution. The presumed goal is to make it appear as if the code will conditionally branch, but in actual fact, the execution always resumes at the same location. A first example:

| | |
|---|---|
| 01 ... | |
| 02 js | somewhere |
| 03 jns | somewhere |

The instruction at 01 is irrelevant because the conditional jumps that follow are each other's opposites. At 02 there is a branch if the sign flag is set, then at 03 there is a branch if the flag is not set. The result is therefore that one of the branches is always taken.

Another example:

| | |
|---|---|
| 01 stc | |
| 02 jc | somewhere |

At 01 the code creates a known state for the carry flag by explicitly setting it. Then at 02 there is a branch if the carry flag is set—which, at this point, it always is. So again the branch destination is always reached unconditionally.

To cause an unconditional branch in this indirect way would not be typical for compiler generated code, but is an indication of suspicious code.

### Obsolete Instructions

A second situation relates to instructions and operations that in a given context can be considered obsolete. The expression “obsolete instruction” is intended to indicate an instruction which has no purposeful meaning in the current programming content.

For example, on a x86 processor the 32-bit mode is an extension of the 16-bit mode so 16-bit instructions and registers continue to be valid. However, several of the 16-bit instructions make no sense in 32-bit mode. One such example is the pushf instruction that is used to preserve the state of CPU flags. The instruction has been superseded by pushfd, which is aware of and able to preserve an extended set of flags. A similar situation exists for pusha/pushad that are used to preserve general-purpose CPU registers. Also other instructions exist that are rarely used or where the operand size may be suspicious. By detecting the presence of such obsolete instructions, improper code can be detected.

Depending on the implementation of the emulator used, it may be possible to look for more operations. The environment is again Microsoft Windows running on an Intel x86 compatible CPU. System modules use the syscall instruction and int 2e operation to transfer control into kernel mode as they request execution of system services. The emulator may track which module is currently executing and realize that a non-system module is issuing this type of request. It would be very suspicious if such an event were to occur.

### Redirected Execution Flow

A third situation is when a function does not return to the position from which the function was called, but to a different position in the code, or not at all. This behavior is not something you will normally encounter in compiled mode.

It may be useful when emulating some environments, which do not natively have it, to use a separate call stack for verifying function returns. Also, depending on how one chooses to implement such a stack, it may be useful to monitor the stack height and compare to checkpoints that are recorded during execution. For example, it would be possible to detect all variants of the get-delta code commonly seen in viruses that utilize a relative addressing scheme. Consider the following example.

| | |
|---|---|
| 01 add | eax, 3 |
| 02 call | 03 |
| 03 pop | ebp |
| 04 sub | eax, 2 |

It is assumed that the stack height is 0 at step 01. When step 02 is executed the stack height becomes 4 since the return address is stored on the stack. A checkpoint is made because a presumed new function is entered. If step 03 is allowed to execute the stack height goes back to 0, because the return address is popped into a register. Then at step 04, the stack height is clearly below the valid minimum height given by the previous checkpoint.

There are a few cases when this kind of code does however exist in legitimate application code. One such example is from code developed using the Microsoft tool chain. During the function prologue, and structured exception handling (SEH) handler set up, the code that configures the SEH frame is sometimes, for several reasons, placed into a separate block that uses a non-standard return that violates the heuristic rules presented in this section. The following example illustrates what it looks like for some version of the linker:

| | | |
|---|---|---|
| .4FEFAD5E | mov | eax,04FF52226 |
| .4FEFAD63 | call | .04FEE14F0 |
| ... | | |
| .4FEE14F0 | push | −1 |
| .4FEE14F2 | push | eax |
| .4FEE14F3 | mov | eax,fs:[000000000] |
| .4FEE14F9 | push | eax |
| .4FEE14FA | mov | eax,[esp][00C] |
| .4FEE14FE | mov | fs:[0],esp |
| .4FEE1505 | mov | [esp][00C],ebp |
| .4FEE1509 | lea | ebp,[esp][00C] |
| .4FEE150D | push | eax |
| .4FEE150E | retn | |

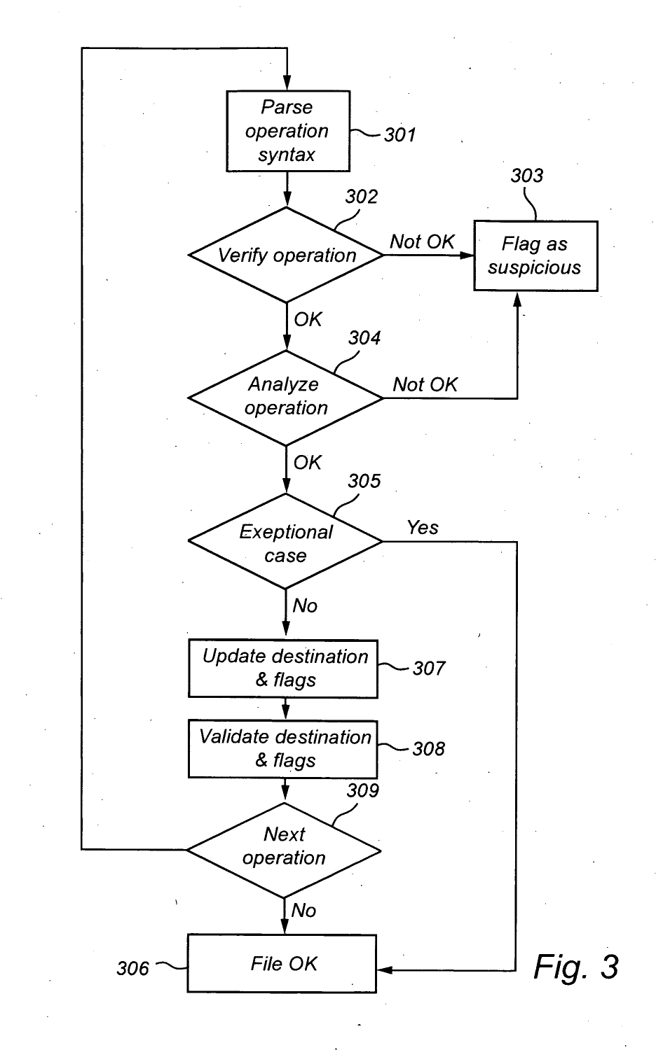

Returning now to the description of the code emulation module 205, FIG. 3 shows a flow chart of the analysis performed by the code emulation module 205 to identify suspicious code, for example based on the situations discussed above.

In step 301 an operation of the prepared data is parsed, i.e. it is dissembled to determine individual instructions, operands, prefixes, etc. It is noted that an “operation” may be either a code statement or an instruction or a sequence of instructions, depending on the type of code that is being analyzed and emulated.

In step 302 the operation components are verified in order to reveal suspicious code. For example, an instruction can be verified to ensure that it is not obsolete, as discussed above under “Obsolete instructions”. Further, a source operand can be verified to ensure it is not uninitialized, as discussed above under “Uninitialized source operands”. Further yet, both source and destination operands can be verified to ensure they do not refer to a negative stack location. If any one of the verifications results in the operation classified as suspicious, program control continues to step 303, where the data collection is flagged as “suspicious”.

If the parsed operation is verified, program control continues to step 304, where preparations are made to perform emulation. For example, a destination operand can be analyzed to see if a computed value is overwritten before it is used, as discussed above under “Invalid operation sequences”. Also, the stack can be analyzed if this is an operation that modifies it. Such an analysis can reveal a call which will not return to its originating position, as discussed above under “Redirected execution flow”. If the analysis results in the operation being classified as suspicious, program control continues to step 303, where the data collection is flagged as “suspicious”.

In step 305, which may be performed within step 304, exceptional cases such as division by zero are identified. In the event of such exceptional cases program control may be transferred to an exception handler, or the analysis may be aborted and the data collection be classified as benign (step 306). The reasoning for aborting is that, that by the time rigged exceptions go off, other properties of the code should have already allowed the analysis to flag the file as suspicious.

In step 307 destinations and flags are updated according to the operation that is being processed.

In step 308 a record that tracks the status (initiated or uninitiated) of emulated locations such as registers, variables and stack is updated based on the operation that is being processed. This information is used in the analysis of the subsequent operation in step 304.

In step 309, the program counter is incremented, and program control returns to step 301 to parse any subsequent operation. If there are no more operations, the process terminates in step 306.

Note that, for most of the described examples, the code emulator can be limited to emulating events on a processor level. For example, to successfully detect invalid source operands, it is typically sufficient to emulate interaction between the processor and the stack and selected registers. However, any conventional emulator, including more complex emulators, may be used for purposes of the present invention.

The person skilled in the art realizes that the present invention by no means is limited to the preferred embodiments described above. On the contrary, many modifications and variations are possible within the scope of the appended claims. For example, the described method may include additional steps, to further improve the detection. The detection method described herein may also be combined with other types of malware/virus detection methods.

What is claimed is:

1. A method for identifying a data collection as malware or virus, comprising the steps of:
parsing said data collection to generate program code and to verify conformance to a language syntax,
emulating the interaction between said program code and a processor,
detecting presence of a portion of said program code that is likely to have been added to the program code for the purpose of avoiding detection by malware detection programs, and
in the presence of such code, identifying said data collection as malware or virus.

2. The method according to claim 1, wherein said detecting step includes detecting contents of an uninitiated variable or register being read by the program code.

3. The method according to claim 1, wherein said detecting step includes detecting a reference to a negative stack.

4. The method according to claim 1, wherein said detecting step includes detecting a result of a sequence of operations being discarded in a final step of the sequence.

5. The method according to claim 1, wherein said detecting step includes detecting an obsolete instruction present in the program code.

6. The method according to claim 1, wherein said detecting step includes detecting a return from a function called from a first position in the program code being made to a second position in the program code or not at all.

7. The method according to claim 1, wherein said detecting step includes detecting an unconditional execution of a branch instruction expressed as a conditional execution.

8. The method according to claim 1, wherein said emulating step includes emulation of at least one of a processor stack, processor registers, and processor instructions.

9. The method according to claim 8, wherein said emulation of registers only includes keeping track of register status, without keeping track of actual values.

10. The method according to claim 1, wherein said added program code has been added to the program code during one of an expansion phase of a polymorphic malware, a polymorphic virus, or a decryption layer.

11. A system for identifying a data collection as malware or virus, comprising:
a parser for parsing said data collection to generate program code and to verify conformance to a language syntax,
an emulator for emulating the interaction between said program code and a processor, and
an analyzer for detecting presence of a portion of said program code that is likely to have been added to the program code for the purpose of avoiding detection by malware detection programs, and, in the presence of such code, identifying said data collection as malware or virus.

12. The system according to claim 11, wherein said analyzer Is arranged to detect contents of an uninitiated variable or register being read by the program code.

13. The system according to claim 11, wherein said analyzer Is arranged to detect a reference to a negative stack.

14. The system according to claim 11, wherein said analyzer Is arranged to detect a result of a sequence of operations being discarded in a final step of the sequence.

15. The system according to claim 11, wherein said analyzer Is arranged to detect an obsolete instruction present in the program code.

16. The system according to claim 11, wherein said analyzer Is arranged to detect a return from a function called from a first position in the program code being made to a second position in the program code or not at all.

17. The system according to claim 11, wherein said analyzer Is arranged to detect an unconditional execution of a branch instruction expressed as a conditional execution.

18. The system according to claim 11, wherein said emulator is arranged to emulate at least one of a processor stack, processor registers, and processor instructions.

19. The system according to claim 18, wherein said emulation of registers only includes keeping track of register status, without keeping track of actual values.

20. The system according to claim 6, wherein said added program code has been added to the program code during one of an expansion phase of a polymorphic malware, a polymorphic virus, or a decryption layer.
